(19) United States
(12) Patent Application Publication
(10) Pub. No.: US 2025/0390824 A1
(43) Pub. Date: Dec. 25, 2025

(54) WORKFLOW DEVELOPMENT PLATFORM

(71) Applicant: Schlumberger Technology Corporation, Sugar Land, TX (US)

(72) Inventors: Swapnil Dubey, Pune (IN); Abhijeet Sawant, Pune (IN); Mahesh Kumar Daksha, Pune (IN); Pawan Kumar Gupta, Pune (IN)

(21) Appl. No.: 19/243,207

(22) Filed: Jun. 19, 2025

(30) Foreign Application Priority Data
Jun. 19, 2024 (IN) 202411047211

(51) Int. Cl. G06Q 10/0633

(52) U.S. Cl. CPC G06Q 10/0633

(57) ABSTRACT

Systems and methods presented herein are configured to provide a workflow development platform configured to provide a user interface to a user device, to receive user interaction data entered via the user interface, to generate a data artifact based on the user interaction data, to parse the data artifact to generate a directed acyclic graph, and to provide the directed acyclic graph to an orchestrator.

### CROSS-REFERENCE TO RELATED APPLICATION

This application claims priority to and the benefit of Indian Application No. 202411047211, entitled “WORKFLOW DEVELOPMENT PLATFORM,” filed Jun. 19, 2024, which is hereby incorporated by reference in its entirety for all purposes.

### BACKGROUND

The present disclosure generally relates to systems and methods for providing a workflow development environment for creating, registering, and using workflows to be deployed in various business activities.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Petrotechnical data is collected from various domains of upstream business, spanning drilling simulation, seismic, well placement, reservoir characterization, reservoir simulation, fracture modeling, geological modeling, gridding and upscaling, well and completion design to production design and optimization, and so on. Automated workflows may be used to ingest, process, publish, and draw insights from this data.

### SUMMARY

A summary of certain embodiments described herein is set forth below. It should be understood that these aspects are presented merely to provide the reader with a brief summary of these certain embodiments and that these aspects are not intended to limit the scope of this disclosure.

In certain embodiments, a method includes providing, via a workflow development platform, a user interface to a user device. The method also includes receiving, via the workflow development platform, user interaction data entered via the user interface. The method further includes generating, via the workflow development platform, a data artifact based on the user interaction data. In addition, the method includes parsing, via the workflow development platform, the data artifact to generate a directed graph. The method also includes providing, via the workflow development platform, the directed graph to an orchestrator.

In addition, in certain embodiments, a workflow development platform includes one or more processors configured to execute processor-executable instructions stored in memory of the workflow development platform. The processor-executable instructions include instructions that, when executed by the one or more processors, cause the workflow development platform to provide a user interface to a user device, to receive user interaction data entered via the user interface, to generate a data artifact based on the user interaction data, to parse the data artifact to generate a directed acyclic graph, and to provide the directed acyclic graph to an orchestrator.

In addition, in certain embodiments, a workflow development platform is configured to provide a user interface to a user device, to receive user interaction data entered via the user interface, to generate a data artifact based on the user interaction data, to parse the data artifact to generate a directed acyclic graph, and to provide the directed acyclic graph to an orchestrator.

### BRIEF DESCRIPTION OF THE DRAWINGS

Various aspects of this disclosure may be better understood upon reading the following detailed description and upon reference to the drawings, in which:

FIG. 1 is a schematic of a computing system for developing workflows, in accordance with an aspect of the present disclosure;

FIG. 2 is a schematic of a workflow development process, in accordance with an aspect of the present disclosure;

FIG. 3 is an illustration of an example user interface of a workflow development environment, in accordance with an aspect of the present disclosure;

FIG. 4 is a flowchart of a method for operating a workflow development platform, in accordance with an aspect of the present disclosure; and

FIG. 5 is a block diagram of a workflow development platform, in accordance with an aspect of the present disclosure.

### DETAILED DESCRIPTION

One or more specific embodiments of the present disclosure will be described below. These described embodiments are examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole”, “upper” and “lower,” “top” and “bottom,” and other like terms indicating relative positions to a given point or element are utilized to more clearly describe some elements. Commonly, these terms relate to a reference point as the surface from which drilling operations are initiated as being the top (e.g., uphole or upper) point and the total depth along the drilling axis being the lowest (e.g., downhole or lower) point, whether the well (e.g., wellbore, borehole) is vertical, horizontal or slanted relative to the surface.

In addition, as used herein, the terms “real time”, “real-time”, or “substantially real time” may be used interchangeably and are intended to described operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic” and “automated” are intended to describe operations that are performed or caused to be performed, for example, by a processing system (i.e., solely by the processing system, without human intervention). In addition, as used herein, the term “approximately equal to” may be used to mean values that are relatively close to each other (e.g., within 5%, within 2%, within 1%, within 0.5%, or even closer, of each other).

The present disclosure relates to a software service that provides a workflow development environment in which a user (e.g., data manager) may create, register, and use workflows to be deployed in various petrotechnical business activities, such as oilfield operations (e.g., exploration, drilling, production). The workflow development environment may be integrated with a data aggregation platform, such as Open Subsurface Data Universe (OSDU), which provides frameworks for storing, accessing, organizing, and managing data across different organizations and across different domains within those organizations. Using the workflow development environment, a user may create workflows to be implemented via an orchestrator for data engineering pipelines. For example, the workflow development environment may capture user interactions with a user interface and generate a directed graph, such as a directed acyclic graph (DAG) defining tasks of the workflow. Then, the orchestrator (e.g., Apache Airflow) may manage the scheduling and execution of the workflow based on the DAG. In this way, the workflow development environment may function as a user-friendly layer of abstraction above the technology (e.g., Python scripts) underlying the orchestrator and the data aggregation platform. Thus, barriers to usage of the data aggregation platform may be lowered, making workflow development accessible to less technically inclined users.

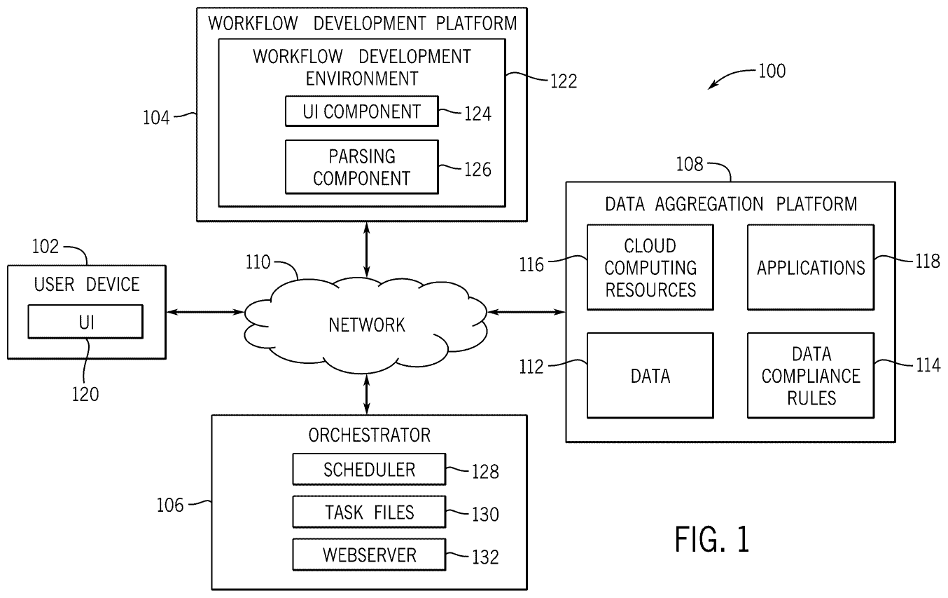

FIG. 1 illustrates a computing system 100 that includes a user device 102, a workflow development platform 104, an orchestrator 106, and a data aggregation platform 108 connected to each other via a network 110. The network 110 enables a user of the user device 102 to access the workflow development platform 104 to develop workflows associated with the data aggregation platform 108. The data aggregation platform 108 stores data 112 and enforces data compliance rules 114 regarding the format, structure, source, and quality of the data 112. Additionally, the data aggregation platform 108 may include cloud computing resources 116 configured to run applications 118 integrated with the data aggregation platform 108. A user working within the framework provided by the data aggregation platform 108 may seek to access, manipulate, analyze, and/or publish data on the data aggregation platform 108 as part of workflows. Additionally, the workflows themselves may be registered with the data aggregation platform 108 based on compliance with the data compliance rules. According to existing methods, interfacing with the data aggregation platform 108 may require a level of technical expertise (e.g., programming knowledge) barring would-be users from creating such workflows. The workflow development platform 104 described herein is configured to bridge the gap between users and the data aggregation platform 108 by wrapping a user interface 120 around the architecture and code that are typically used to develop workflows.

The user device 102 may be a PC, a laptop, a mobile device, or any other suitable computing device. In certain embodiments, the user device 102 may function as a client device to a server hosting the workflow development platform 104 as a service. The workflow development platform 104 may be a remote computing system (e.g., server, cloud computing system) configured to host the workflow development environment 122 as an application or a service accessible via the user device (e.g., client) 102. The workflow development environment 122 includes a user interface (UI) component 124 configured to provide a UI 120 (e.g., graphical user interface) to a display of the user device 102. The UI 120 may include windows, graphics, menus, user input fields, diagrams, and/or drag-and-drop features that enable the user to define one or more workflows in a user-friendly manner. As the user interacts with the UI 120, the workflow development environment 122 may capture and convert the user activity (e.g., inputs, definitions) into a data artifact (e.g., file). For example, the data artifact may be an object formatted as a Javascript Object Notation (JSON) file. The workflow development environment 122 further includes a parsing component 126 (e.g., parsing library, application programming interface (API)) configured to generate a directed graph such as a directed acyclic graph (DAG) based on the data artifact.

In general, the DAG (e.g., DAG file) contains tasks, arranged with dependencies and data flows taken into account. Dependencies between tasks define the order in which to execute the tasks. The tasks may include fetching data, running analysis, triggering other systems, and so forth. In this way, the DAG represents a workflow defined by the user using the UI 120 in a data format that can be interpreted and executed by the orchestrator 106. Although DAGs are primarily described herein (e.g., directed graphs having no directed cycles), in other embodiments, other types of directed graphs defining workflow tasks (e.g., vertices of the directed graphs) and dependencies (e.g., edges of the directed graphs) may be determined by the workflow development platform 104, as described herein.

In general, the orchestrator 106 is configured to manage and execute DAGs, such as the DAG generated via the workflow development environment 122. In certain embodiments, the orchestrator 106 may include a folder storing multiple DAG files. Additionally, the orchestrator 106 may include a scheduler 128 configured to read the DAGs to determine what tasks to run (e.g., utilizing task files 130), and when and where to run the tasks. Additionally, the orchestrator 106 may include a webserver 132 configured to provide an orchestrator UI for users to inspect, trigger, and debug the behavior of DAGs and tasks.

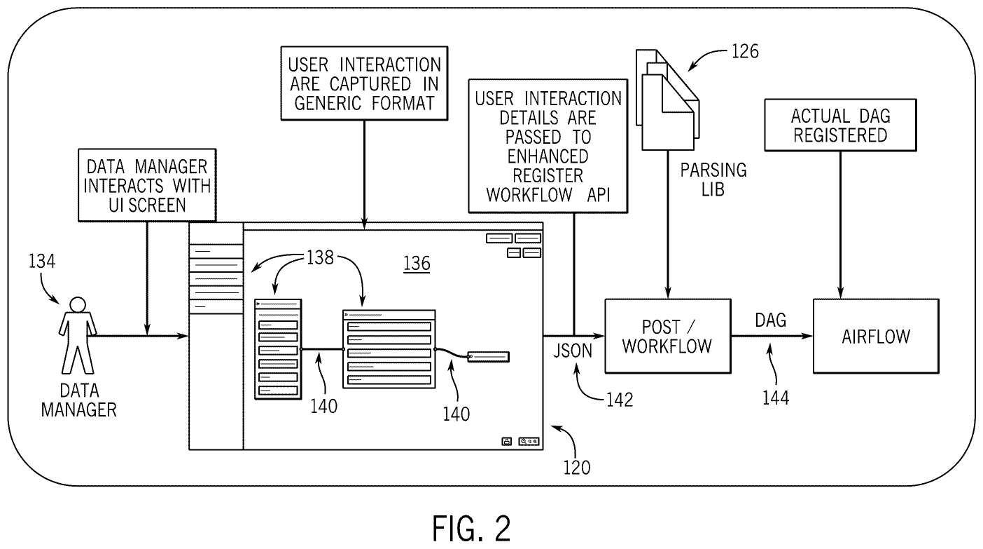

FIG. 2 illustrates a workflow development process utilizing the workflow development environment 122. First, a user 134 (e.g., data manager) may interact with the UI 120 provided by the workflow development environment 122 via the user device 102. In the UI 120, the user 134 may populate a workspace 136 with various graphical elements 138 (e.g., blocks, arrows) representing parts of the workflow, such as tasks, data, dependencies, data flow, logical operators, and so on. Additionally, the user 134 may populate various fields (e.g., enabled by the graphical elements 138) with parameters and other inputs associated with the workflow. By creating a graphical representation of the workflow and associating certain parameters with corresponding graphical elements 138, the user 134 is able to define (e.g., configure) a workflow. For example, the workflow may include a series of tasks to be performed in a specified sequence, for example, as represented by arrows (or other connections) 140 between graphical elements 138 residing in the workspace 136. In certain embodiments, multiple users 134 may collaborate within the same workspace 136. For example, the workflow development platform 104 may serve the UI 120 to two, three, four, or more user devices 102, each able to view, modify, and/or otherwise interact with the workspace 136. Different users 134 may have different permissions to interact with the workspace 136. For example, some users 134 may be given permission to modify the workflow while other users 134 may only view the workspace 136. In any case, the data and graphical elements 138 in the workspace 136 define the workflow as intended by the user(s) 134. Once complete, the information defined by the workspace 136 may be converted into a data artifact 142 having a generic data format, such as JSON. In certain embodiments, the workflow development platform 104 may access an API to convert the workspace information into the data artifact 142.

After the data artifact 142 is generated, the parsing component 126 (e.g., parsing library) of the workflow development platform 104 may parse (e.g., analyze, process) the data artifact 142 to generate a DAG 144. For example, the parsing component 126 may ascertain the information recorded in the data artifact 142 including the identities of the tasks, the order of the tasks, the dependencies between the tasks, the parameters set by the user 134, and so forth. Then, the parsing component 126 may generate a DAG file 144 containing the information provided by the user 134, wherein the information is transformed into a data format that is readable and executable by the orchestrator 106.

After the DAG 144 is generated, the orchestrator 106 may then register the workflow with the data aggregation platform 108. Upon registration with the data aggregation platform 108, the workflow may be integrated with the data aggregation platform 108 to access the data stored thereon, as well as interact with other workflows and/or applications on the data aggregation platform 108. Additionally, the workflow may be shared across a team, an organization, or the world (e.g., via open-source).

Further, the orchestrator 106 may execute the workflow (e.g., the tasks) once registered. In certain embodiments, the tasks may be executed across a distributed architecture orchestrated via the orchestrator 106. For example, the orchestrator 106 may schedule certain tasks to be performed via certain computing resources (e.g., Kubernetes pods). The tasks may include requesting or retrieving data from the data aggregation platform 108, as well as publishing data to the data aggregation platform 108. To this end, the orchestrator 106 (e.g., its constituent computing resources) may communicate with the data aggregation platform 108 (e.g., via an API) to interact with the contents stored thereon. Additionally, the orchestrator 106 may reference the data compliance rules of the data aggregation platform 108 to determine how to execute the workflow in accordance therewith.

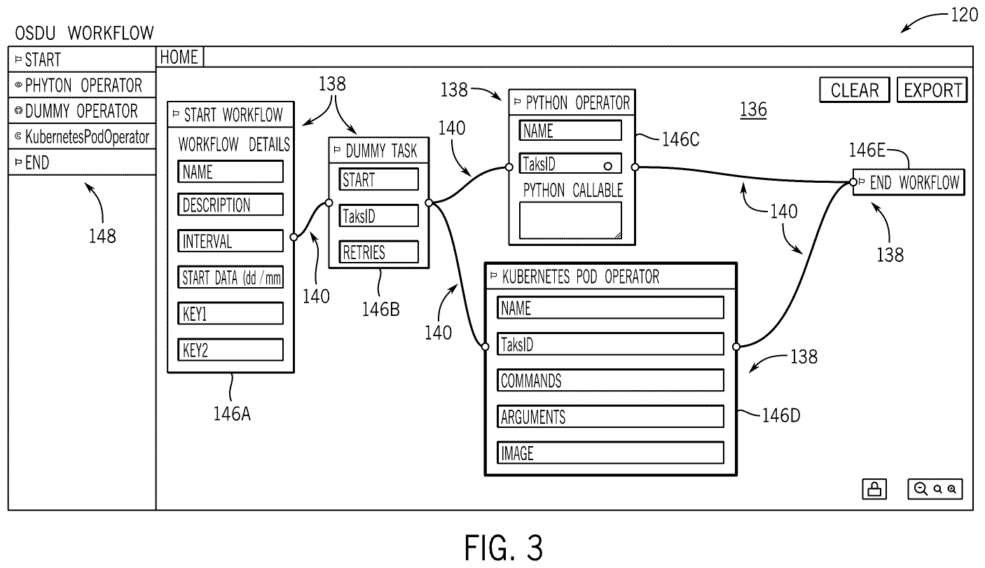

FIG. 3 illustrates an example UI 120 of the workflow development environment 122 as viewed via a user device 102. The graphical elements 138 of the UI 120 may include modules 146 representing tasks, operators, processes, and so forth. For example, a first module 146A may represent initiation of the workflow. For example, as illustrated, the first module 146A may include user input fields configured to receive parameters associated with the workflow, such as a name of the workflow, a description of the workflow, an interval, a start date of the workflow, and keys. The user 134 may further elect to define a task by a second module 146B, a Python operator by a third module 146C, and a Kubernetes pod operator by a fourth module 146D. As illustrated, each of these modules 146 may include user input fields configured to receive relevant data (e.g., parameters, commands, arguments) corresponding to the nature of the module 146. The workflow may end with a fifth module 146E representing the end of the workflow. Additionally, the UI 120 may include data flow paths 140 (e.g., arrows, lines) connecting the modules 146 to define sequences, dependencies, and direction of data flow.

As such, arranged in the workspace 136, the graphical elements 138 define the workflow in a readable and modifiable way. In addition, in certain embodiments, a user may drop-and-drop new modules 146 into the workspace 136 from a menu 148 that includes the module types. In addition, in certain embodiments, a user may create connections 140 between the modules 146 by right-clicking on a first module 146 and then dragging a connection 140 to a second module 146. As such, the UI 120 enables users to easily add, delete, annotate, modify, and so forth, modules 146 and associated connections 140 to define workflows that may be processed, analyzed, and registered with one or more data aggregation platforms 108, as described in greater detail herein, by the workflow development platform 104. It will be appreciated that the example workflow illustrated in FIG. 3 is merely exemplary and is not intended to be limiting. Indeed, an infinite combination of modules 146 and associated flow paths 140 connecting the modules 146 to define workflows may be created by users and then processed and analyzed by the workflow development platform 104 to register the workflows with one or more data aggregation platforms 108, as described in greater detail herein.

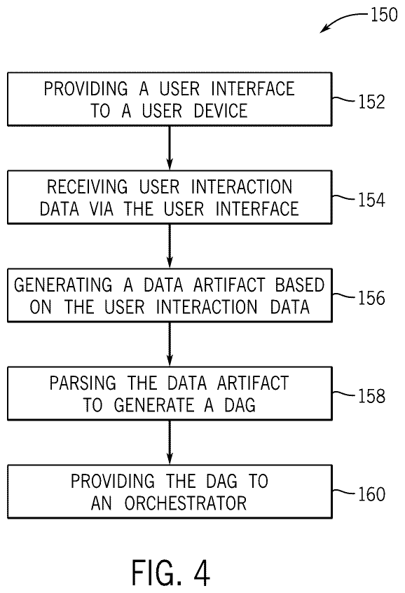

FIG. 4 illustrates a method 150 for operating the workflow development platform 104. The method 150 may be performed by one or more servers, a cloud computing service, or any other suitable computing system hosting the workflow development platform 104. Although the following description of the method 150 is described in a particular order, it should be noted that the method 150 may be performed in any suitable order.

At block 152, the workflow development platform 104 may provide a UI 120 to a user device 102. For example, the workflow development platform 104 may serve an application (e.g., web app) to the user device 102. The application may cause a display of the user device 102 to display the UI 120. The UI 120 may include a workspace 136 and various menus 148. The menus 148 may include a selection of graphical elements 138 (e.g., modules, arrows) configured to be dragged and dropped into the workspace 136. The UI 120 may further include various tools for efficiently adding, deleting, annotating, and modifying graphical elements 138 in the workspace 136.

At block 154, the workflow development platform 104 may receive user interaction data provided by the user 134 via the UI 120. The user interaction data may include any information contained within the workspace 136, such as the identities of tasks and operators, data flow paths, user inputs (e.g., parameters, arguments), and/or metadata associated with user activity in the workflow development environment 122, such user interaction data defining a particular workflow. In certain embodiments, the workflow development platform 104 may receive user interaction data from multiple users 134 and/or user devices 102 collaborating on the development of the workflow.

At block 156, the workflow development platform 104 may generate a data artifact 142 based on the user interaction data. In certain embodiments, the user interaction data (e.g., from the workspace 136) may be captured in a generic data format (e.g., JSON). For example, the workflow development platform 104 may ascertain features of the workspace 136 (e.g., of the modules 146 and associated connections 140 and the data defined thereby) such as the positions of graphical elements 138, values entered in user input fields, and/or relationships between the graphical elements 138. These features may be recorded in the generic data format to form the data artifact 142.

At block 158, the workflow development platform 104 may parse the data artifact 142 to generate a DAG file 144. In certain embodiments, a parsing component 126 (e.g., parsing library) of the workflow development platform 104 may include tools to generate DAG file elements corresponding to respective elements of the data artifact 142.

At block 160, the workflow development platform 104 may provide the DAG file 144 to an orchestrator 106 for registration, management, and/or execution of the workflow defined by the DAG 144. In certain embodiments, the orchestrator 106 may be implemented on the same machine (e.g., server) as the workflow development platform 104. Alternatively, a first server (or group of servers) hosting the workflow development platform 104 may communicate, via a network 110, with a second server (or group of servers) running the orchestrator 106. Then, the DAG file 144 may be transmitted from the first server to the second server via the network 110 to facilitate registration, management, and/or execution of the workflow defined by the DAG 144 with one or more data aggregation platforms 108, as described in greater detail herein.

In addition, in certain embodiments, the workflow development platform 104 may register the DAG 144 with the data aggregation platform 108 by converting data associated with the DAG 144 from an organization-specific domain to an industry-specific domain based at least in part on an identity of an organization associated with a user entering the user interaction data via the UI 120. For example, various organizations may use organization-specific terminology that is only relevant to that specific organization. As such, the workflow development platform 104 may need to transform certain organization-specific terminology into a data format consistent with more industry-standard terminology used by the data aggregation platform 108.

In certain embodiments, the workflow development platform 104 may be configured to utilize machine learning algorithms to identify relationships between the organization-specific domain and the industry-specific domain based at least in part on data associated with the DAG 144. In certain embodiments, the machine learning algorithms may be configured to identify the relationships between the organization-specific domain and the industry-specific domain based at least in part on an identity and/or role of the user entering the user interaction data via the UI 120 relative to an organization associated with the user. For example, a user with a more management-related role may enter data that is different than another user with a more engineering-related role. As such, the workflow development platform 104 may be capable of converting the data entered by both types of users based on their specific role (and, therefore, based on their relative technical knowledge level).

In addition, in certain embodiments, the workflow development platform 104 may be configured to generate one or more mappings between the organization-specific domain and the industry-specific domain for use in future registrations of other DAGs 144 with the data aggregation platform 108. As such, the workflow development platform 104 may be capable of enabling more efficient conversion of future DAGs 144 for registration and use with a specific data aggregation platform 108.

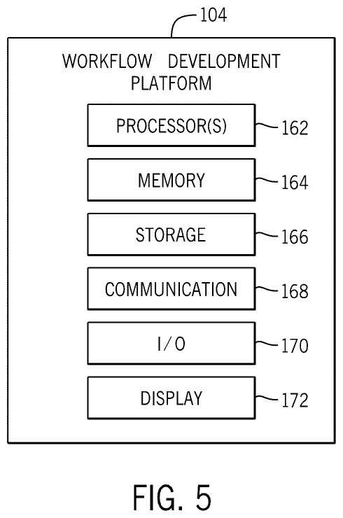

FIG. 5 illustrates an embodiment of the workflow development platform 104 and its components. The workflow development platform 104 may be a remote computing system, a server, or a group of servers configured to host the workflow development environment 122 (e.g., as a web application) described herein. As such, the workflow development platform 104 may include one or more processors 162, one or more memory media 164, one or more storage media 166, a communication component 168, input/output (I/O) ports 170, a display 172, and so forth. The processor(s) 162 may include any type of computer processor or microprocessor capable of executing computer-executable code. In certain embodiments, the processors may include multiple processors that perform the operations described herein by, for example, sharing processing functions.

The memory and storage media 164, 166 may be any suitable articles of manufacture that can serve as media to store processor-executable code, data, and so forth. These articles of manufacture may represent computer-readable media (e.g., any suitable form of memory or storage) that may store the processor-executable code used by the processor(s) 162 to perform the presently disclosed techniques. As used herein, applications may include any suitable computer software or program that may be installed onto the workflow development platform 104 and executed by the processor(s) 162. The memory and storage media 164, 166 may represent non-transitory computer-readable media (e.g., any suitable form of memory or storage) that may store the processor-executable code used by the processor(s) 162 to perform various techniques described herein. It should be noted that non-transitory merely indicates that the media is tangible and not a signal.

The communication component 168 may be a wireless or wired communication component that may facilitate communication between various components of the network 110, such as the user device 102, the orchestrator 106, the data aggregation platform 108, and/or the internet. Additionally, the communication component 168 may facilitate data transfer to the workflow development platform 104 such that the workflow development platform 104 may receive data from the other components depicted in FIG. 1, and so forth.

The I/O ports 170 may be interfaces that may couple to other peripheral components such as input devices (e.g., keyboard, laser scanner, mouse, microphone), sensors, input/output (I/O) modules, and so forth. The display 172 may depict visualizations associated with software or executable code being processed by the processor(s) 162. The display 172 may be any suitable type of display, such as a liquid crystal display (LCD), plasma display, or an organic light emitting diode (OLED) display, for example.

The specific embodiments described above have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A method, comprising:
providing, via a workflow development platform, a user interface to a user device;
receiving, via the workflow development platform, user interaction data entered via the user interface;
generating, via the workflow development platform, a data artifact based on the user interaction data;
parsing, via the workflow development platform, the data artifact to generate a directed graph; and
providing, via the workflow development platform, the directed graph to an orchestrator.

2. The method of claim 1, wherein the directed graph comprises a directed acyclic graph.

3. The method of claim 1, comprising registering, via the orchestrator, the directed graph with a data aggregation platform.

4. The method of claim 3, wherein the data aggregation platform comprises the Open Subsurface Data Universe (OSDU).

5. The method of claim 3, wherein registering, via the workflow development platform, the directed graph with the data aggregation platform comprises converting data associated with the directed graph from an organization-specific domain to an industry-specific domain based at least in part on an identity of an organization associated with a user entering the user interaction data via the user interface.

6. The method of claim 5, comprising utilizing, via the workflow development platform, machine learning algorithms to identify relationships between the organization-specific domain and the industry-specific domain based at least in part on the data associated with the directed graph.

7. The method of claim 6, wherein the machine learning algorithms are configured to identify the relationships between the organization-specific domain and the industry-specific domain based at least in part on an identity and/or role of the user relative to an organization associated with the user.

8. The method of claim 6, comprising generating, via the workflow development platform, one or more mappings between the organization-specific domain and the industry-specific domain for use in future registrations of other directed graphs with the data aggregation platform.

9. A workflow development platform, comprising:
one or more processors configured to execute processor-executable instructions stored in memory of the workflow development platform, wherein the processor-executable instructions comprise instructions that, when executed by the one or more processors, cause the workflow development platform to:
provide a user interface to a user device;
receive user interaction data entered via the user interface;
generate a data artifact based on the user interaction data;
parse the data artifact to generate a directed acyclic graph; and
provide the directed acyclic graph to an orchestrator.

10. The workflow development platform of claim 9, wherein the processor-executable instructions comprise instructions that, when executed by the one or more processors, cause the workflow development platform to register, via the orchestrator, the directed acyclic graph with a data aggregation platform.

11. The workflow development platform of claim 10, wherein registering the directed acyclic graph with the data aggregation platform comprises converting data associated with the directed acyclic graph from an organization-specific domain to an industry-specific domain based at least in part on an identity of an organization associated with a user entering the user interaction data via the user interface.

12. The workflow development platform of claim 11, wherein the processor-executable instructions comprise instructions that, when executed by the one or more processors, cause the workflow development platform to utilize machine learning algorithms to identify relationships between the organization-specific domain and the industry-specific domain based at least in part on the data associated with the directed acyclic graph.

13. The workflow development platform of claim 12, wherein the machine learning algorithms are configured to identify the relationships between the organization-specific domain and the industry-specific domain based at least in part on an identity and/or role of the user relative to an organization associated with the user.

14. The workflow development platform of claim 12, wherein the processor-executable instructions comprise instructions that, when executed by the one or more processors, cause the workflow development platform to generate one or more mappings between the organization-specific domain and the industry-specific domain for use in future registrations of other directed acyclic graphs with the data aggregation platform.

15. A workflow development platform configured to:
provide a user interface to a user device;
receive user interaction data entered via the user interface;
generate a data artifact based on the user interaction data;
parse the data artifact to generate a directed acyclic graph; and
provide the directed acyclic graph to an orchestrator.

16. The workflow development platform of claim 15, wherein the workflow development platform is configured to register, via the orchestrator, the directed acyclic graph with a data aggregation platform.

17. The workflow development platform of claim 16, wherein registering the directed acyclic graph with the data aggregation platform comprises converting data associated with the directed acyclic graph from an organization-specific domain to an industry-specific domain based at least in part on an identity of an organization associated with a user entering the user interaction data via the user interface.

18. The workflow development platform of claim 17, wherein the workflow development platform is configured to utilize machine learning algorithms to identify relationships between the organization-specific domain and the industry-specific domain based at least in part on the data associated with the directed acyclic graph.

19. The workflow development platform of claim 18, wherein the machine learning algorithms are configured to identify the relationships between the organization-specific domain and the industry-specific domain based at least in part on an identity and/or role of the user relative to an organization associated with the user.

20. The workflow development platform of claim 18, wherein the workflow development platform is configured to generate one or more mappings between the organization-specific domain and the industry-specific domain for use in future registrations of other directed acyclic graphs with the data aggregation platform.
